(19) United States
(12) Patent Application Publication
(10) Pub. No.: US 2007/0194585 A1
(43) Pub. Date: Aug. 23, 2007

(54) Electro mechanical locking apparatus for RV slide out

(76) Inventors: Linda Lee Roberts, Gladwater, TX (US); Tim Roberts, Gladewater, TX (US)

Correspondence Address: Galasso & Associates, LP, P.O. Box 26503, Austin, TX, 78755-0503, US

(21) Appl. No.: 11/357,690

(22) Filed: Feb. 17, 2006

(51) Int. Cl. B60P 3/34

(52) U.S. Cl. 296/26.01

(57) ABSTRACT

An electro-mechanical slide out locking mechanism (EMSOLM) is disclosed that can lock a slide out unit of a mobile structure. In a particular embodiment the EMSOLM can have a rigid member that is connected to a transmission and an actuator. The actuator could be an electric motor, a solenoid or any other device that can convert electrical energy into mechanical movement. The actuator can have a mounting surface that is clamped or connected to a recreational vehicle or a slide out unit. The actuator can drive the transmission to move the rigid member in relationship to the mounting surface. The actuator can be connected to a switch via wires and the switch can be connected to a power system or batteries. Activating the switch can move the rigid member into position such that is locks the slide out unit in an extended or retracted position.

### FIELD OF THE DISCLOSURE

The present disclosure is generally related to large “drawer type” structures that can slide out from a sidewall of a mobile structure, such as a slide out unit on a recreational vehicle and more particularly to locking mechanisms for such slide out units.

### BACKGROUND

Sales of recreational vehicles continue to grow at a robust pace. Recreational vehicles are used for many purposes such as camping, luxury traveling, wintering in a southern climate, and tailgating at sports events. Recreational vehicles come in many shapes, sizes and configurations. For example, some recreational vehicles come in the form of a motor home, which has a cockpit that allows a driver to navigate the motor home down the road. Other RV configurations include a gooseneck, a fifth wheel or a tag type trailer that has some area offering shelter space for the RV operator. For example, some RV trailers may allow for hauling a racecar or horses, yet allocate space for lounging. Additionally, custom RV trailers are often utilized on the set where a movie is being filmed and in addition to providing a lounging area may have a dressing room and make up area.

Many RVs are manufactured with at least one slide out. A slide out generally is a structure that can slide in and out in relation to the sidewall of the RV. When a slide out is in the “out” position the floor space or “living area” of the RV can be significantly increased. A slide out can be described as a large “drawer,” possibly six foot tall by ten foot wide by four foot deep. When the RV is parked, the slide out can be deployed or extended to increase the useable interior space of the RV. Before the RV is driven or pulled down the road, the slide out can be retracted such that the RV does not exceed the legal width. A typical side out has some form of locking mechanism to lock the slide out in both the extended position and the retracted position.

Thus many RV systems, such as locks for slide outs need to be properly configured when the RV systems are to be set up or torn down. This process of setting up and tearing down RV systems is considered a burdensome process for many RV owners. Especially, older owner who may have mobility problems. In a typical RV, many space saving features are implemented. In some RV's with slide outs, there is not an adequate amount of room on one side of the slide out to access the manual slide out lock. Thus, some manufactures chose to put a slide out lock on only one side of the slide out. In time, a single lock can distort the shape of the slide out because it applies an uneven/one sided force on the slide out. Thus, it is desirable to have a locking mechanism on both sides of the slide out unit.

Additionally, if the slide out unit is not locked in the retracted position, vibration during travel can move the slide out outward a small distance. A slide out that moves out from the wall of the RV even a fraction of an inch can create a gap between the sealing surfaces of the slide out and the sidewall of the RV. Such a gap will allow rain to enter the RV, and over extended periods of time seriously water damage can occur to the RV possibly costing thousands of dollars. Thus, it is important to lock the slide out when it is in the retracted position. Accordingly, there is a need for an improved method and system to set up and tear down recreational vehicle systems.

### BRIEF DESCRIPTION OF THE DRAWINGS

FIG. 1 is a rear view drawing of recreational vehicle that has a slide out in the extended position and a slide out lock, locking the slide out in the extended position;

FIG. 2 is a view of an electromechanical slide out locking mechanism; and

FIG. 3 is a rear view drawing of recreational vehicle that has a slide out in the retracted position and a slide out lock, locking the slide out in the retracted position.

### DETAILED DESCRIPTION OF THE DRAWINGS

More and more mobile structures such as recreational vehicles utilize slide out units or slide outs. When a recreational vehicle (RV) operator decides to move from a location where the RV systems have been deployed, the RV systems must be “torn down.” This tear down procedure typically requires a series of sequential events to prevent damage to the RV and its systems. For example, if a slide out is in the out or extended position a locking mechanism is often utilized to lock the slide out in this position. If the RV operator activates the mechanism (referred to herein as a carriage) that extends and retracts the slide out, and the locking mechanism for the slide out has not been unlocked, damage can occur to the carriage, to the slide out, and to the locking mechanism. This problem is exacerbated because many RV operators are renters of the RV and are not familiar with proper operation of such systems. Another significant problem with RV systems is that when the slide out is not properly locked in the retracted position water can enter the RV around the slide out seal causing damage. Thus, it would be desirable to have an RV with systems that are more automated and thus easier to set up and tear down.

In accordance with the present invention, an electromechanical locking apparatus can be utilized to lock a slide out when the slide out is in the extended position and when the slide out is in the retracted position. Further, the locking mechanism can be automatically activated based on other user actions such as activating a switch to extend or retract the slide out unit.

Additionally, the locking mechanism can automatically be configured responsive to the switches that activate the carriage system. The electro-mechanical locking mechanism can utilize a motor to drive a gear or a lead screw that in turn can drive or move a rigid member that locks and unlocks the slide out.

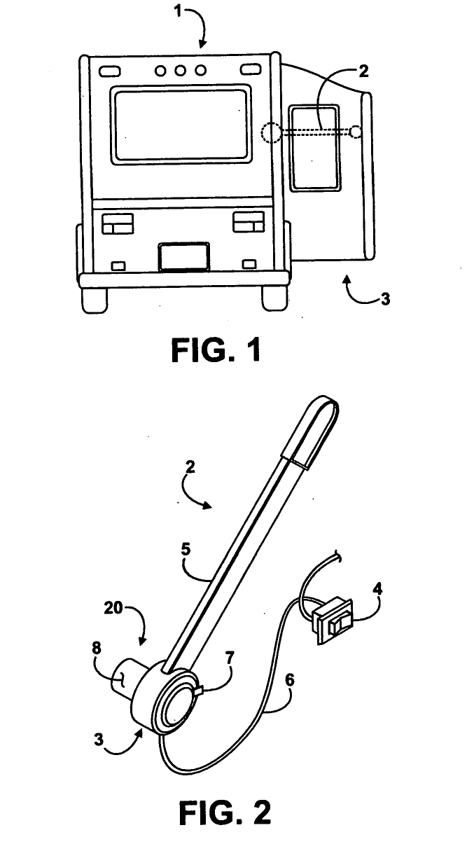

Referring to FIG. 1 a mobile structure (MS) 1 that can provide some form of shelter is illustrated. The mobile structure could be a recreational vehicle, a motor home, a travel trailer, a fifth wheel trailer, a gooseneck trailer, a racecar trailer, a horse trailer or some other type of trailer or motor vehicle. The MS 1 has a slide out unit (SOU) 3 that can slide out when the MS 1 is parked and the SOU 3 can be retracted when the MS 1 is to be moved or stored. In FIG. 1, the SOU 3 is shown in the “out” or extended position. A carriage system is often utilized to slidably connect the SOU 3 to the MS 1 such that a mechanism such as a hand crank or an electric motor can be utilized to extend or retract the SOU 3. A typical carriage system employs slides having rollers, sometimes similar to drawer slides, however on a larger scale.

When the SOU 3 is in the extended or “out” position, electromechanical slide out locking mechanism (EMSOLM) 2 can move into a position that locks the SOU 3 in the extended position as shown. When the SOU 3 needs to be retracted, the rigid member 5 can be moved possibly rotated such that it “un-locks” the SOU 3 and the SOU 3 can be retracted inward.

Often, a switch is utilized to activate the carriage system and extend or retract the SOU 3. This switch is often located away from the location of the SOU 3. Thus, when a user is tearing down the systems they may activate the carriage system without unlocking the slide out locking mechanism. This can cause damage to the carriage system. In a specific embodiment the EMSOLM 2 can be interconnected with the switch that activates the carriage system such that the carriage system will not operate when the EMSOLM 2 is in the locked position. In another embodiment, the EMSOLM 2 can be automatically activated and moved to the unlock position prior to activation of the carriage to retract the SOU 3.

Referring to FIG. 2, an illustrative embodiment of an electromechanical slide out locking mechanism (EMSOLM) 2 is provided. In a particular embodiment, the EMSOLM 2 can have a rigid member 5 that is connected to transmission 3, and an actuator 20. The actuator 20 could be an electric motor, a solenoid or any other device that can convert electrical energy into mechanical movement. Actuator 20 can have a mounting surface 8 that is clamped or connected to a recreational vehicle or a slide out unit (not shown). Actuator 20 can drive transmission 3 and in turn transmission 3 can move rigid member 5 in relationship to the mounting surface 8. Actuator 20 can be connected to switch 4 via wire 6 and switch can be connected to a power system or batteries (not shown).

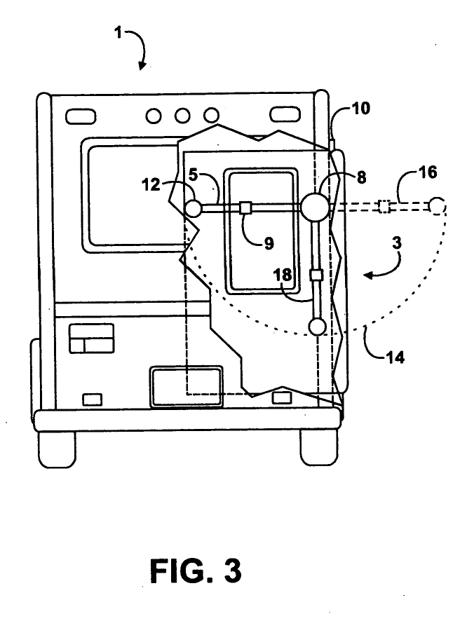

In operation, when a user activates the switch 4 and via the switch 4, power can be supplied to actuator 20. As the actuator 20 turns gears in the transmission 3 components of the transmission 3 can turn and correspondingly arm or rigid member 5 can move into a position that will lock a slide out unit as illustrated in FIGS. 1 and 3. In the embodiment illustrated, the transmission 3 may contain gears such as planetary gears, worm gears or a lead screw.

In other embodiments, the transmission may be a lead screw or use other gear type mechanisms and have additional pivoting mechanical arms such as a scissors arrangement to assist in moving the rigid member 5 into a position that will lock or unlock a slide out unit. In a specific embodiment the actuator 20 can be a 12-volt motor such that it can be supplied with power from the internal power system of an RV. In another embodiment, the actuator 20 can operate with other voltages such as twenty-four volts or even one hundred ten volts AC.

In a specific embodiment a position sensor/interlock 7 is provided such that the position sensor/interlock 7 can provide a signal such as a wireless signal or a signal via wires 6 to indicate whether the rigid member 5 is in the locked or unlocked position or somewhere in between. In other embodiments, the position sensor/interlock 7 can be mounted separately from the EMSOLM 2. In yet another embodiment, the signal from the position sensor/interlock 7 can be coupled to other systems such as an alarm system or an interlock system to ensure that the EMSOLM 2 is in the proper position. Further, the position sensor interlock can assist the motor to ensure that the EMSOLM 2 is either in the lock position of the unlock position such that the EMSOLM 2 will not stop in an “in-between” position. In a specific embodiment, a switch for the carriage system (not shown) can be interlock with the position sensor/interlock 7 such that the carriage system will not operate unless the EMSOLM 2 is in an unlocked position.

In a specific embodiment the length of rigid member 5 can be adjustable such that the same EMSOLM 2 can be utilized for slide outs that have different dimensions and the EMSOLM 2 can also be mounted at different locations. Further, an adjustable length rigid member can allow the EMSOLM 2 not to be located exactly in the center of between the extended and retracted position. Further, shims could be provided where the moving end of the EMSOLM 2 engages the SOU such that the EMSOLM 2 does not have to be centered.

FIG. 3 provides a cut away rear view of the mobile structure (MS) 1. As stated above, the MS 1 can have a slide out unit (SOU) 3 that can be extended when the MS 1 is parked, and be retracted for transport, storage or when the additional floor space provided by the SOU 1 is not desired. In FIG. 3, the SOU 3 is shown in the “in” or retracted position. When the SOU 3 is in the retracted position, rigid member 5 of the electromechanical slide out locking mechanism (EMSOLM) 2 can be moved to a position to lock the SOU 3 in the retracted position as shown. When the SOU 3 is extended and needs to be retracted the EMSOLM 2 can be moved so that it “unlocks” the SOU 3.

When the SOU 3 is “fully” retracted the EMSOLM 2 can be rotated to lock the SOU 3 in the retracted position. Thus, when the EMSOLM 2 moves from an extended lock position to a retracted lock position to lock the EMSOLM 2 can be rotated one hundred eighty degrees illustrated by phantom semicircle 14.

The EMSOLM 2 can have wear pads or roller assemblies 9 and 12 that can reduce operating friction and any scraping that may occur as the EMSOLM 2 moves from position to position or along the imaginary path illustrated by dashed line 14.

When a RV 1 is prepared for travel or for long term storage and the SOU 3 is in the extended position the EMSOLM 2 can be moved from the extended lock position 16 (shown in phantom) to an unlock position 18 (in a vertical position) and when the SOU 3 is retracted the EMSOLM 2 can be rotated to a retracted locking position wherein the rigid member 5 is inboard from the mounting surface 8.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A slide out lock apparatus comprising:
a rigid member pivotable about a first end;
a transmission coupled to the first end of the rigid member, the transmission configured to accept a rotational input; and
an electric motor coupled to the transmission and configured to provide the rotational input, the slide out lock apparatus coupleable to a mobile structure wherein the rigid member moves in relation to the mobile structure to lock a slide out unit of the mobile structure in a fixed location.

2. The slide out lock apparatus of claim 1 wherein the slide out is locked in one of a retracted position or an extended position.

3. The slide out lock apparatus of claim 1 further comprising a wear pad proximate to the rigid member.

4. The slide out lock apparatus of claim 1 wherein the transmission further comprises at least one gear.

5. The slide out lock apparatus of claim 1 wherein the transmission further comprises a lead screw.

6. The slide out lock apparatus of claim 1 wherein the first end of the rigid member is coupled to the mobile structure proximate to a sidewall of the mobile structure.

7. The slide out lock apparatus of claim 1 wherein the rigid member is adjustable in length.

8. A locking apparatus comprising:
a rigid member configured to lock a slide out unit of a mobile structure, the slide out unit configured to provide addition space inside of the mobile structure when extended, wherein the rigid member is moveable to a first position to lock the slide out unit, and the rigid member is moveable to a second position to unlock the slide out unit; and
an actuator coupled to the rigid member to facilitate moving the rigid member from the first position to the second position.

9. The locking apparatus of claim 8 wherein the actuator is an electric motor that moves the rigid member in response to a user input.

10. The locking apparatus of claim 8 wherein the actuator is a linear actuator.

11. The locking apparatus of claim 8 further comprising a position sensor configured to detect a position of the rigid member and to produce a signal.

12. The apparatus of claim 10 wherein when the position sensor is coupled to a carriage drive system.

13. The apparatus of claim 8 wherein the actuator moves the rigid arm from the second position to the first position.

14. A method comprising:
activating a switch; and
moving a rigid member to an un-lock position in response to the activation of the switch such that a slide out unit of a mobile structure can be extended to increase the interior space of the mobile unit.

15. The method of claim 14 further comprising moving the rigid member to lock the slide out unit in an extended position responsive to a second activation of the switch.

16. The method of claim 14 further comprising:
sensing a position of the rigid member; and
providing an interlock signal to a carriage system.

17. The method of claim 14 further comprising:
moving a slide out unit of a mobile structure to an extended position; and
locking the slide out with an electromechanical locking member.

18. The method of claim 14 wherein activating the switch further comprises switching electrical power to the actuator.

19. The method of claim 14 further comprising moving the rigid member to a lock position in response to user input.

20. The method of claim 14 wherein the rigid member comprises two rigid members and a hinge.
